(19) United States
(12) Patent Application Publication
(10) Pub. No.: US 2013/0118801 A1
(43) Pub. Date: May 16, 2013

(54) Data Cable And Forming Method Thereof

(71) Applicant: Chi Wen Cheng, Dong Guan City (CN)

(72) Inventor: Chi Wen Cheng, Dong Guan City (CN)

(21) Appl. No.: 13/294,953

(22) Filed: Nov. 11, 2011

(51) Int. Cl. H02G 15/02; B29C 45/14

(52) U.S. Cl. 174/74 R; 264/272.14

(57) ABSTRACT

The invention discloses a data cable and a forming method thereof. The data cable includes a data connector, a transmission line, and an insulating layer utilized to integrally enclose the data connector and the transmission line. The insulating layer includes an upper insulating portion formed in a first forming process and a lower insulating portion formed in a second forming process, wherein upper insulating portion covers on an outer surface of an upper end of the data connector and an outer surface of an upper end of the transmission line, the lower insulating portion covers on an outer surface of a lower end of the data connector and an outer surface of a lower end of the transmission line, and the upper insulating portion and the lower insulating portion formed in the second forming process are plastically attached to each other.

### BACKGROUND OF THE INVENTION

1. Field of the Invention

The invention relates to a data cable, and in particular relates to a data cable having a tidy, smooth and artistic appearance and providing a easily-achieved manufacturing process and a tightly-enclosed insulating layer, and a forming method thereof.

2. Description of the Related Art

With the development of the technologies, digital products such as computers, digital cameras and mobile phones gradually become the necessities to our daily life. In general, the conversion and duplication of data between these digital products shall be transmitted via data cables.

A conventional data cable mainly includes a data connector and a transmission line connected to the data connector. In the manufacturing process, the transmission line is connected to the data connector after the transmission line is drawn and enclosed with an insulating casing, and the outer surface of the data connector and the connection position of the data connector and the transmission line are finally enclosed by an insulating layer.

With the development of the mini electronic products, mini data cables and shorter transmission lines thereof shall be correspondingly provided, such as mini universal serial bus (USB) data cables, mini display port (DP) data cables and mini high definition multimedia interface (HDMI) data cables, etc. However, the cost of the above-described method for manufacturing the mini data cables and transmission lines is high, and the enclosing quality of the connection position of the data connector and the transmission line cannot be precisely controlled. A more simple manufacturing method is further provided, by placing the data connector and the transmission line which are connected in a mold and enclosing an insulating layer on an outer surface of the data connector and an outer surface of the transmission line. However, there still has some deficiencies existing in the actual manufacturing process of this method, for example, the displacement of the transmission line caused by unevenness of upper and lower pressures in the mold, uneven thickness of the insulating layer enclosing the displaced transmission line, and unstable product quality.

For solving the displacement of the transmission line above, positioning needles are usually disposed in the mold for positioning the transmission line. However, corresponding positioning holes are often formed on the outer surface of the insulating layer disposed on the transmission line, thus impairing the protection effect of the insulating layer to the transmission line therein and decreasing the smoothness and artistic appearance of the data cables.

Accordingly, it is necessary to study a new technology project to solve the problems.

### BRIEF SUMMARY OF THE INVENTION

In view of the deficiencies of the above-described conventional skills, the purpose of the present invention mainly provides a data cable and a forming method thereof to produce a tightly-enclosed insulating layer and a data cable having a tidy, smooth and artistic appearance.

To achieve the purposes above, the invention is adopted with the technology projects as follows.

A data cable comprises a data connector, a transmission line, and an insulating layer utilized to integrally enclose an outer surface of the data connector and an outer surface of the transmission line. The insulating layer comprises an upper insulating portion formed in a first forming process and a lower insulating portion formed in a second forming process, wherein the upper insulating portion is correspondingly covered on an outer surface of an upper end of the data connector and an outer surface of an upper end of the transmission line, the lower insulating portion is correspondingly covered on an outer surface of a lower end of the data connector and an outer surface of a lower end of the transmission line, and the upper insulating portion and the lower insulating portion formed in the second forming process are plastically attached to each other.

A method for forming a data cable providing a data connector and a transmission line connected to the data connector. The method further comprises the steps of:

(a1) preparing a first forming mold formed with a mold cavity shaped to match the data connector and the transmission line and disposing the data connector and the transmission line which are assembled in the first forming mold wherein an outer surface of a lower end of the data connector and an outer surface of a lower end of the transmission line are snuggly attached to a wall surface of the mold cavity of the first forming mold such that an outer surface of an upper end of the data connector and an outer surface of an upper end of the transmission line are integrally formed with and enclosed by an upper insulating portion;

(a2) removing the data connector and the transmission line which are integrally enclosed by and formed with the upper insulating portion;

(a3) preparing a second forming mold formed with a mold cavity and placing the data connector and the transmission line which are integrally enclosed by and formed with the upper insulating portion in the second forming mold to snuggly attach the outer surface of the upper end of the data connector and the outer surface of the upper end of the transmission line to a wall surface of the mold cavity of the second forming mold such that the outer surface of a lower end of the data connector and the outer surface of a lower end of the transmission line are integrally formed and enclosed a lower insulating portion as well as the upper insulating portion and the lower insulating portion formed in the second forming process are plastically attached to each other to form an insulating layer integrally enclosing the outer surface of the data connector and the outer surface of the transmission line; and

(a4) removing the data cable enclosed by the insulating layer in the previous step (a3).

In comparison with the conventional skills, the technology projects of the present invention physically provide the advantages and beneficial effects as follows.

With the outer surface of the data connector and the outer surface of the transmission line integrally enclosed by the insulating layer formed by two different forming processes, the displacement of the transmission line caused by unevenness of upper and lower pressures in the mold and uneven thickness of the insulating layer can be effectively solved. Because conventional positioning needles are not required in the mold of the present invention, there is no positioning hole formed on the outer surface of the insulating layer, and therefore the data cable has a tidy, smooth and artistic appearance and a tightly-enclosed insulating layer.

Further, the insulating layer is formed by two different forming processes, so that the upper insulating portion and the lower insulating portion can be formed by materials with different colors. Because the outer surface of the insulating layer is presented by two different colors, the data cable can be correctly installed in an insertion direction according to the color arrangement thereon.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a main view of a first forming mold of a first embodiment of the invention;

FIG. 2 is a side view of the first forming mold of the first embodiment of the invention;

FIG. 3 is a side view of a product formed in a first forming process of the first embodiment of the invention;

FIG. 4 is an enlarged schematic view showing a cross section of line B-B in FIG. 3;

FIG. 5 is a main view of a second forming mold of a first embodiment of the invention;

FIG. 6 is a side view of the second forming mold of the first embodiment of the invention;

FIG. 7 is a perspective schematic view of a product formed in a second forming process of the first embodiment of the invention;

FIG. 8 is a main view of a first forming mold of a second embodiment of the invention;

FIG. 9 is a side view of the first forming mold of the second embodiment of the invention;

FIG. 10 is a side view of a product formed in a first forming process of the second embodiment of the invention;

FIG. 11 is an enlarged schematic view showing a cross section of line C-C in FIG. 10;

FIG. 12 is a main view of a second forming mold of a second embodiment of the invention;

FIG. 13 is a side view of the second forming mold of the second embodiment of the invention;

FIG. 14 is a perspective schematic view of a product formed in a second forming process of the second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

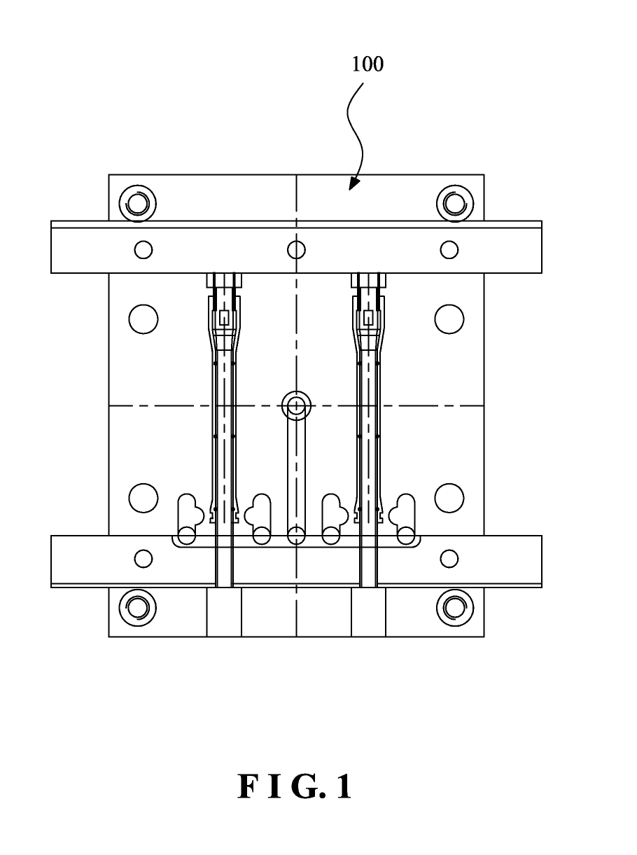

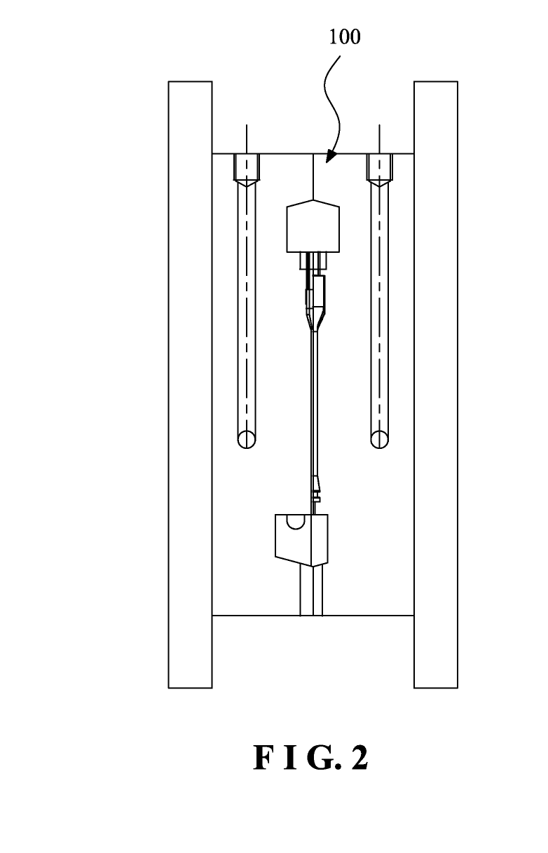

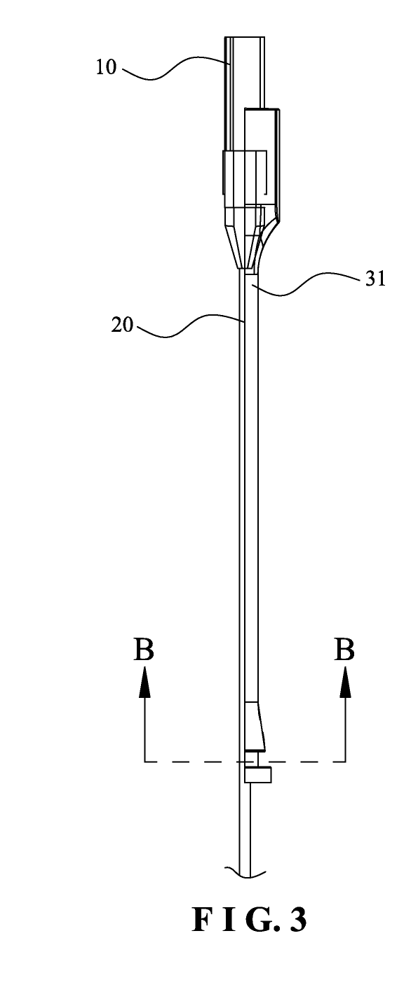

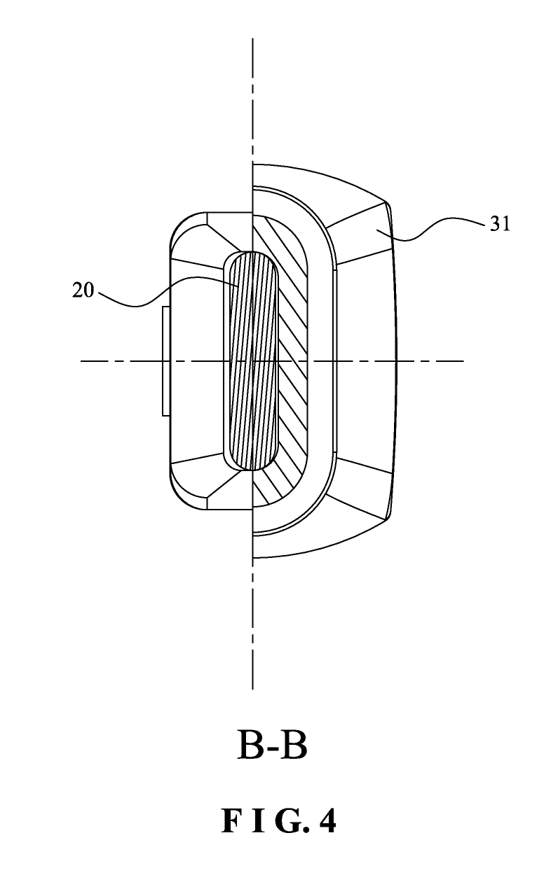

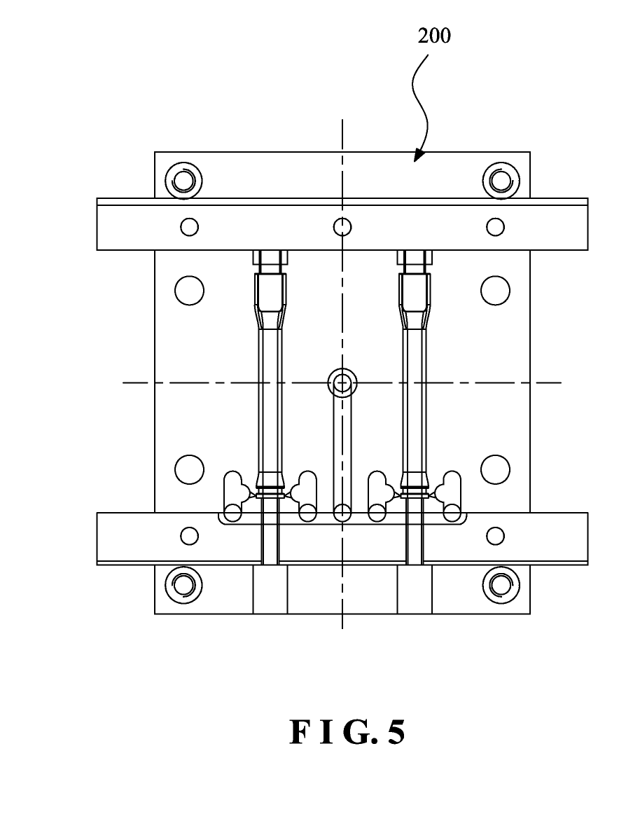

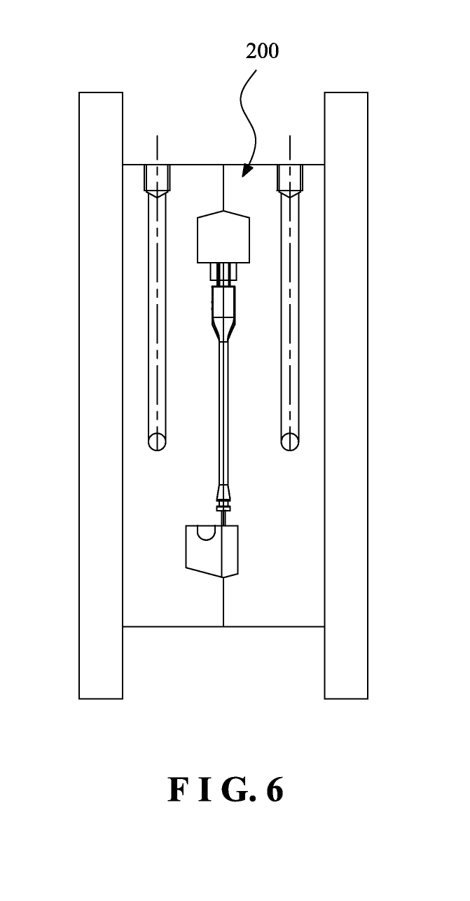

Referring to FIGS. 1 to 7, a physical structure of a data cable of a first embodiment of the invention is illustrated. A mini display port (DP) data cable, taken for an example in the description of this embodiment, comprises a data connector 10, a transmission line 20, and an insulating layer 30 utilized to integrally enclose an outer surface of the data connector 10 and an outer surface of the transmission line 20. The insulating layer 30 comprises an upper insulating portion 31 formed in a first forming process and a lower insulating portion 32 formed in a second forming process, the upper insulating portion 31 of the insulating layer 30 is correspondingly covered on an outer surface of an upper end of the data connector 10) and an outer surface of an upper end of the transmission line 20), the lower insulating portion 32) of the insulating layer 30) is correspondingly covered on an outer surface of a lower end of the data connector 10) and an outer surface of a lower end of the transmission line 20), and the upper insulating portion 31) and the lower insulating portion 32) formed in the second forming process are plastically attached to each other.

The method for forming the data cable of the present invention is described below. First, the data connector 10) and the transmission line 20 are provided to connect to the data connector 10). The method further comprises the steps of:

(a1) preparing a first forming mold formed with a mold cavity shaped to match the data connector and the transmission line and disposing the data connector and the transmission line which are assembled in the first forming mold wherein an outer surface of a lower end of the data connector and an outer surface of a lower end of the transmission line are snuggly attached to a wall surface of the mold cavity of the first forming mold, such that, with the transmission line and the data connector capable of being properly positioned, an outer surface of an upper end of the data connector and an outer surface of an upper end of the transmission line are integrally formed with and enclosed by an upper insulating portion, i.e., conventional positioning needles are not required in the present invention;

(a2) removing the data connector and the transmission line which are integrally enclosed by and formed with the upper insulating portion;

(a3) preparing a second forming mold formed with a mold cavity and placing the data connector and the transmission line which are integrally enclosed by and formed with the upper insulating portion in the second forming mold to snuggly attach the outer surface of the upper end of the data connector and the outer surface of the upper end of the transmission line to a wall surface of the mold cavity of the second forming mold such that, with the transmission line and the data connector which are integrally formed with and enclosed by the upper insulating portion to be capable of being properly positioned, the outer surface of a lower end of the data connector and the outer surface of a lower end of the transmission line is integrally formed with and enclosed by a lower insulating portion as well as the upper insulating portion and the lower insulating portion formed in the second forming process are plastically attached to each other to form an insulating layer integrally enclosing the outer surface of the data connector and the outer surface of the transmission line; and

(a4) removing the data cable enclosed by the insulating layer in the previous step (a3).

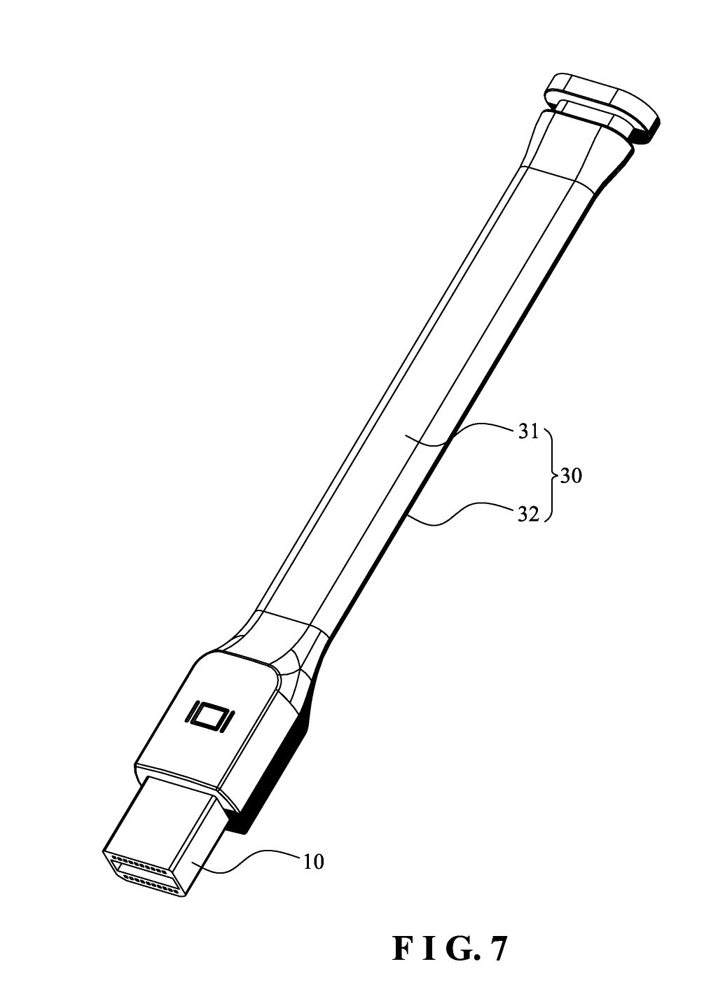

It is noted that the upper insulating portion 31 and the lower insulating portion 32 can be formed by materials with different colors, as the effects illustrated in FIG. 7. Two different colors are presented on the outer surface of the insulating layer 30, so that the data cable can be correctly installed in an insertion direction according to the color arrangement thereon.

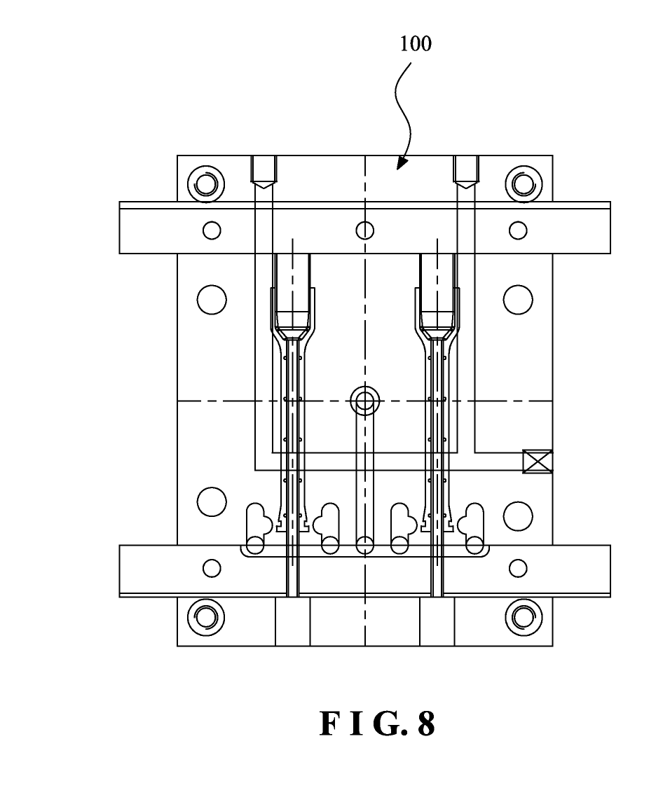

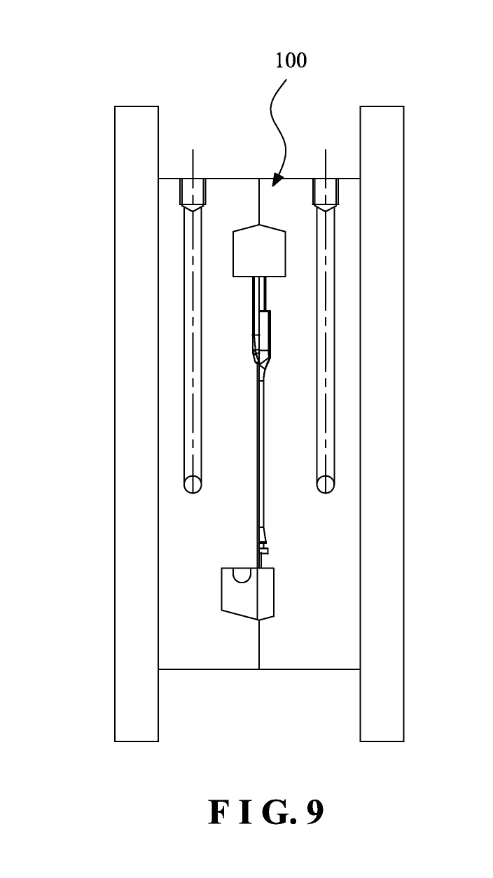

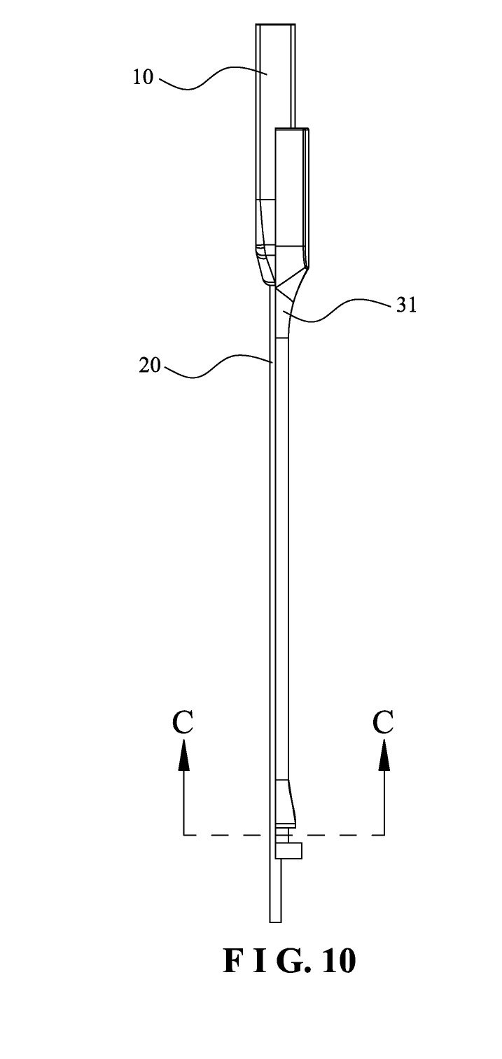

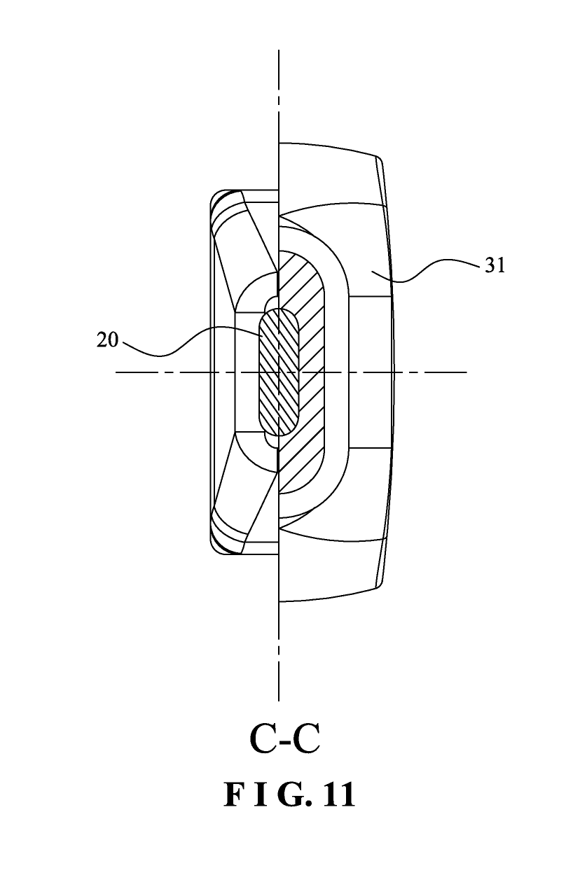

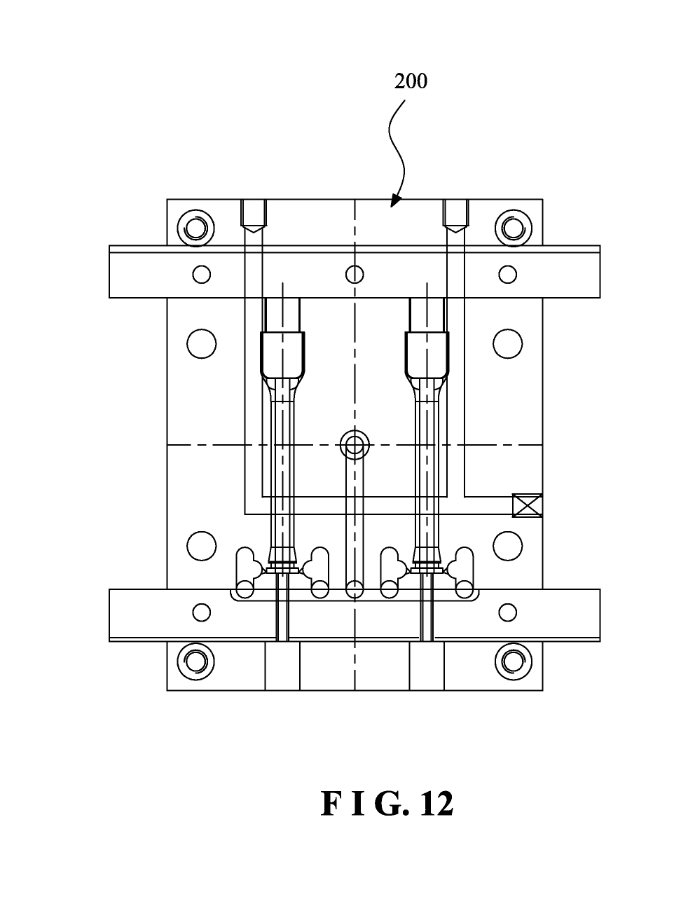

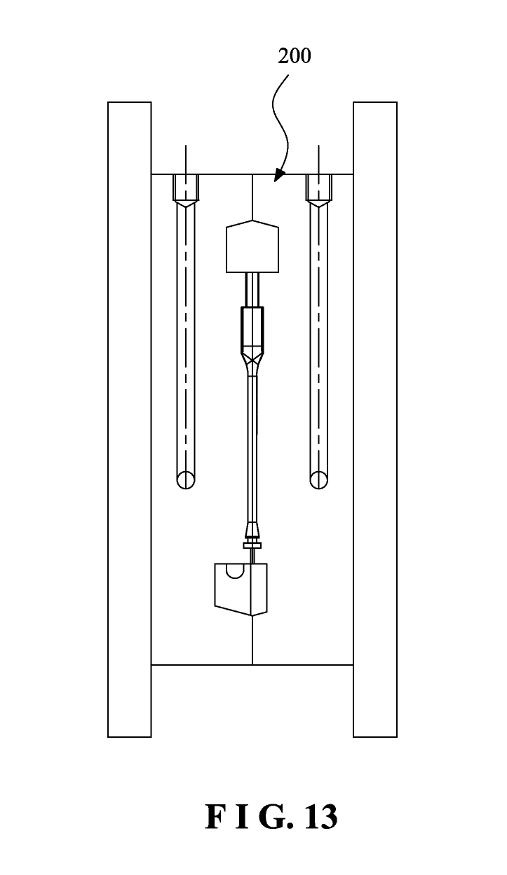

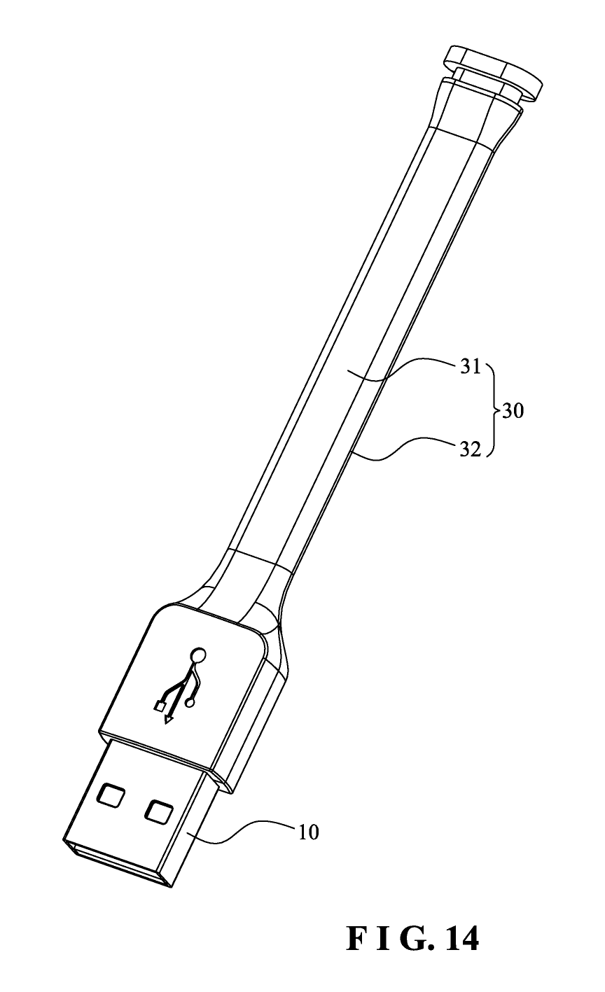

Referring to FIGS. 8 to 14, a physical structure of a data cable of a second embodiment of the invention is illustrated. A mini universal serial bus (USB) data cable, taken for an example in the description of this embodiment. The technical project of the present invention is suitable for the production of the mini USB data cable. It is understood that the technical project of the present invention is suitable for the productions of the mini high definition multimedia interface (HDMI) data cable and other mini data cables, but the description is omitted here.

What is claimed is:

1. A data cable characterized in that the data cable comprises a data connector, a transmission line, and an insulating layer utilized to integrally enclose an outer surface of the data connector and an outer surface of the transmission line, the insulating layer comprises an upper insulating portion formed in a first forming process and a lower insulating portion formed in a second forming process, the upper insulating portion of the insulating layer is correspondingly covered on an outer surface of an upper end of the data connector and an outer surface of an upper end of the transmission line, the lower insulating portion of the insulating layer is correspondingly covered on an outer surface of a lower end of the data connector and an outer surface of a lower end of the transmission line, and the upper insulating portion and the lower insulating portion formed in the second forming process are plastically attached to each other.

2. The data cable as claimed in claim 1, characterized in that the upper insulating portion and the lower insulating portion are formed by materials with different colors.

3. The data cable as claimed in claim 1, characterized in that the data connector is a mini universal serial bus connector.

4. The data cable as claimed in claim 1, characterized in that the data connector is a mini display port connector.

5. The data cable as claimed in claim 1, characterized in that the data connector is a mini high definition multimedia interface connector.

6. A method for forming a data cable providing a data connector and a transmission line connected to the data connector, characterized in that the method further comprises the steps of:
preparing a first forming mold formed with a mold cavity shaped to match the data connector and the transmission line and disposing the data connector and the transmission line which are assembled in the first forming mold wherein an outer surface of a lower end of the data connector and an outer surface of a lower end of the transmission line are snuggly attached to a wall surface of the mold cavity of the first forming mold such that an outer surface of an upper end of the data connector and an outer surface of an upper end of the transmission line are integrally formed with and enclosed by an upper insulating portion;
removing the data connector and the transmission line which are integrally enclosed by and formed with the upper insulating portion;
preparing a second forming mold formed with a mold cavity and placing the data connector and the transmission line which are integrally enclosed by and formed with the upper insulating portion in the second forming mold to snuggly attach the outer surface of the upper end of the data connector and the outer surface of the upper end of the transmission line to a wall surface of the mold cavity of the second forming mold such that the outer surface of a lower end of the data connector and the outer surface of a lower end of the transmission line are integrally formed and enclosed a lower insulating portion as well as the upper insulating portion and the lower insulating portion formed in the second forming process are plastically attached to each other to form an insulating layer integrally enclosing the outer surface of the data connector and the outer surface of the transmission line; and
removing the data cable enclosed by the insulating layer in the previous step.
